(19) United States
(12) Patent Application Publication
(10) Pub. No.: US 2017/0124308 A1
(43) Pub. Date: May 4, 2017

(54) Smart Wearable Device and Unlocking Method Thereof

(71) Applicant: Acer Incorporated, New Taipei CIty (TW)

(72) Inventor: Shang-Hui CHEN, New Taipei City (TW)

(21) Appl. No.: 15/059,669

(22) Filed: Mar. 3, 2016

(30) Foreign Application Priority Data
Nov. 4, 2015 (TW) 104136279

(51) Int. Cl. G06F 21/31; G06F 21/62; G06F 3/041

(52) U.S. Cl. CPC G06F 21/31; G06F 3/0412; G06F 21/6218

(57) ABSTRACT

A wearable device includes a touch screen, an acceleration sensor, and a processor in communication with both the touch screen and the acceleration sensor. The processor is configured to determine whether a first action event has occurred with the wearable device by monitoring an output of the acceleration sensor, after determining that the first action event has occurred, determine whether a first touch event has occurred by monitoring whether touch-sensitive areas on the touch screen have been touched in a predetermined sequence, and release a lock state of the wearable device when the first touch event has occurred.

### RELATED APPLICATION DATA

This application claims priority under 35 U.S.C. §119 to Taiwan patent application TW 104136279, filed on Nov. 4, 2015, the disclosure of which is incorporated herein by reference in its entirety.

### TECHNICAL FIELD

The present invention relates to a wearable electronic device that incorporates a multi-action unlocking methodology.

### BACKGROUND

In order to secure private data on a smartphone, a locking mechanism is employed whereby certain applications and data can only be accessed after a preset password has been entered by a user. Oftentimes the password is entered via a (telephone) numerical keypad or other user friendly interface. Assuming the entered password matches the preset password, access to data and applications on the smartphone is permitted. Recently, some smartphone operating systems have also begun to support the ability of a user to draw a pattern on the smartphone (rather than entering specific alphanumerical characters) to unlock the smartphone. Before entering the password, however, a user must also first press a power button or supply some other touch screen input to be presented with the password entry user interface.

While such unlocking approaches might work well for handheld smartphones, these approaches might not work as well with smart wearable devices. That is, there may be different user expectations between smartphones and smart wearable devices. As such, using a conventional smart phone unlocking mechanism on a smart wearable device might lead to a less than desirable user experience.

### SUMMARY

Described herein is a method of operating a wearable device having a touch screen, the method comprising: determining whether a first action event has occurred with the wearable device by monitoring an output of an acceleration sensor of the wearable device; after determining that the first action event has occurred, determining whether a first touch event has occurred by monitoring whether touch-sensitive areas on a touch screen of the wearable device have been touched in a predetermined sequence; and releasing a lock state of the wearable device when the first touch event has occurred.

Also described is a wearable device, comprising: a touch screen; an acceleration sensor; and a processor in communication with both the touch screen and the acceleration sensor, the processor configured to: determine whether a first action event has occurred with the wearable device by monitoring an output of the acceleration sensor; after determining that the first action event has occurred, determine whether a first touch event has occurred by monitoring whether touch-sensitive areas on the touch screen have been touched in a predetermined sequence; and release a lock state of the wearable device when the first touch event has occurred.

### BRIEF DESCRIPTION OF THE DRAWINGS

Embodiments are described herein in conjunction with the accompanying drawings, in which:

FIG. 1 depicts a component block diagram of a wearable device according to a first embodiment of the present invention.

FIG. 2 depicts a face of wearable device according to a second embodiment of the present invention.

FIG. 3 depicts a face of wearable device according to a third embodiment of the present invention.

FIG. 4 depicts a face of wearable device according to a fourth embodiment of the present invention.

FIG. 5 depicts a face of wearable device according to a fifth embodiment of the present invention.

FIG. 6 depicts a flowchart of a method for unlocking a wearable device in accordance with an embodiment of the present invention.

### DESCRIPTION OF EXAMPLE EMBODIMENTS

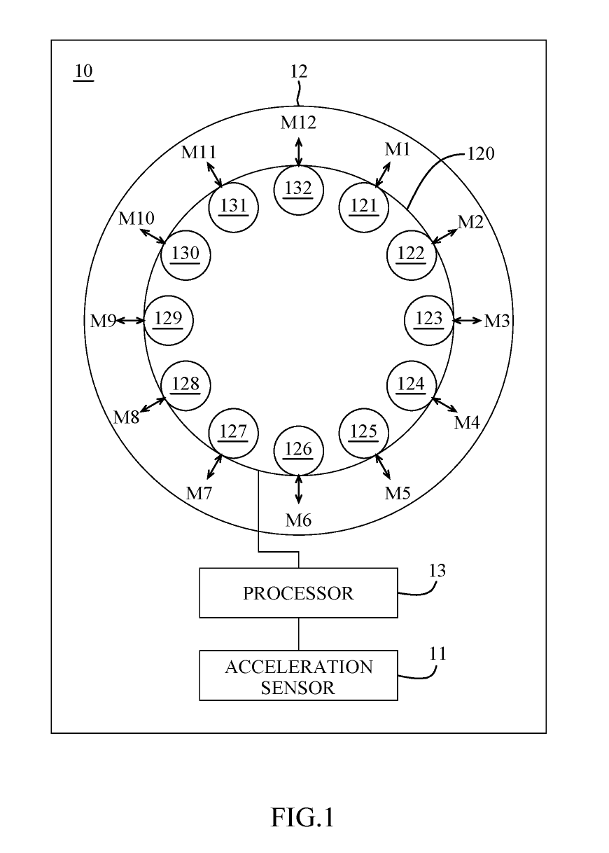

FIG. 1 depicts a component block diagram of a smart wearable device (hereinafter “wearable device”) 10 according to a first embodiment of the present invention. Wearable device 10 may be in the form of a watch, for example, and comprises an acceleration sensor 11, a device surface or face 12, and a processor 13. Acceleration sensor 11 detects, e.g., three-dimensional acceleration parameters in the X, Y and Z axes as a user wearing wearable device moves around. In possible implementations, acceleration sensor 11 may be a G-sensor or a gyroscope. Various movements of wearable device 10 can thus be detected. As part of the unlocking mechanism described herein, movement of wearable device 10 in a particular manner is detected. Specifically, when wearable device 10 is moved in a particular manner that movement is referred to as a “first action event.” In one embodiment, the first action event may be a movement or movements corresponding to a user checking the time displayed on wearable device 10. The movements, and/or sequence of segments of the overall movement, may be detected by processor 13 monitoring output values of acceleration sensor 11, and comparing those values to predetermined values that correspond, in this case, to a user checking the time on wearable device 10. Those skilled in the art will appreciate, however, that the first action event is not limited to a user checking the time, but could be any number of particular movements, which may be predetermined or user customizable.

Referring still to FIG. 1, and in accordance with the first embodiment of the invention, device surface 12 includes a plurality of tick marks M1-M12, and a touch screen 120. Processor 13 is in communication with touch screen 120. Tick marks M1-M12 are disposed around face 12, but not on touch screen 120. Touch screen 120, in conjunction with processor 13, is configured to have corresponding touch-sensitive areas 121 to 132 which have one to one correspondence with tick marks M1-M12. When processor 13 determines, by monitoring the output of acceleration sensor 11, that the first action event has occurred, processor 13 is further configured to then determine whether a predetermined “first touch event” is input via touch-sensitive areas 121 to 132. In one embodiment, the first touch event may be defined as at least two touch-sensitive areas 121 to 132 being touched by a user, and in a particular order or sequence. If processor 13 determines that the first touch event has occurred, processor 13 is configured to release wearable device 10 from a “first state,” e.g., a sleep state or locked state of wearable device 10.

Stated alternatively, processor 13 first determines whether a given first action event has occurred (e.g., a user making movements indicative of looking at his watch), and if so, then determines whether a first touch event has occurred (e.g., a particular sequence of touch events). If processor 13 determines that both the first action event and the first touch event have occurred, this means that a user intends to wake up or unlock wearable device 10, and thus processor 13 is configured to enable wearable device 10 to be released from the first state (e.g., a sleep or locked state) to a second, un-locked, state.

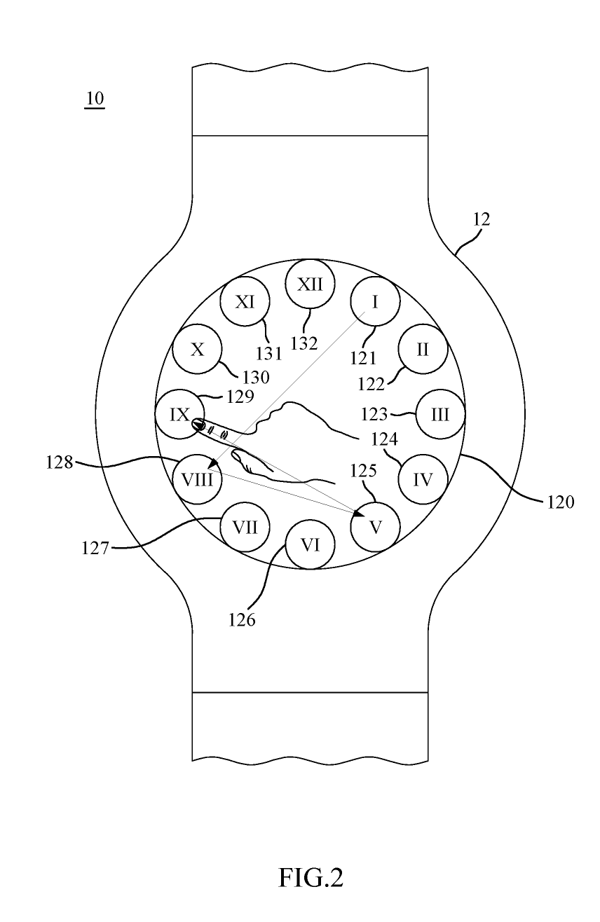

FIG. 2 depicts face 12 of wearable device 10 according to a second embodiment of the present invention. In FIG. 2 tick marks M1-M12 are distributed in 12 different orientations for a timescale or markings of a watch as indicated by Roman numerals I-XII. These tick marks, as before, have a one to one correspondence with touch-sensitive areas 121 to 132. When a user raises his hand to check the displayed time, and processor 13 detects values output by acceleration sensor 11 and determines that the first action event has occurred, processor 13 then detects touch-sensitive areas 121 to 132 to determine whether the first touch event has occurred. The first touch event in this second embodiment of the present invention is a sequence of touches of touch-sensitive areas 121, 128, 125, and 129 (corresponding to the time scale indicated I, VIII, V and IX). The first touch event may also be a sliding action from each touch-sensitive are to the next touch-sensitive area. Of course, other sequences for the first touch event are possible. Thus, when the user sequentially touches the timescale marks I, VIII, V and IX, processor 13 detects touch-sensitive areas 121 to 132 to determine whether the first touch event has occurred and, if so, releases the locked state of wearable device 10.

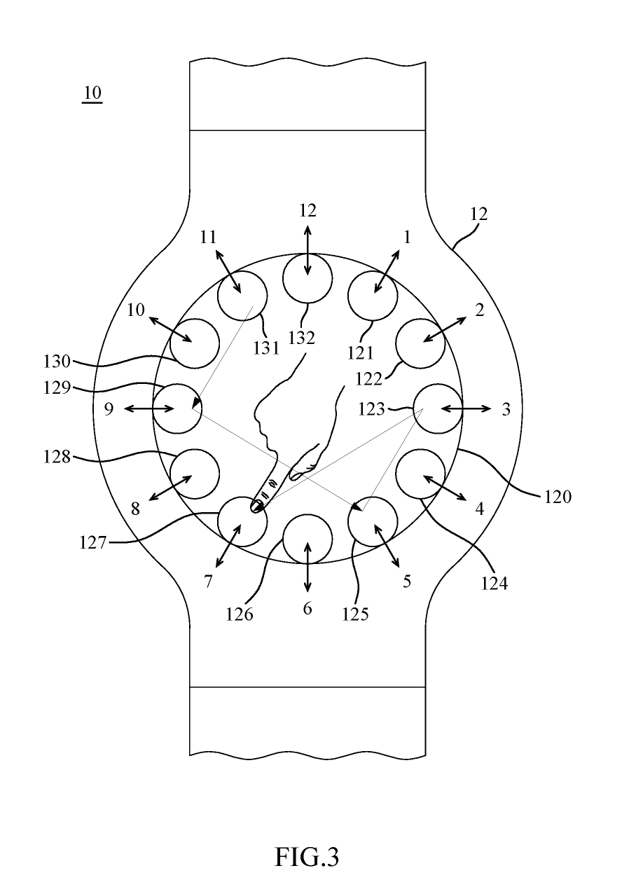

FIG. 3 depicts a face 12 of wearable device 10 according to a third embodiment of the present invention. In the third embodiment of the present invention, tick marks M1-M12 are distributed in the 12 different orientations of timescale marks 1 to 12, and, as before, have one to one correspondence with touch-sensitive areas 121 to 132. The third embodiment of the present invention is different from the second embodiment in that timescale marks 1 to 12 are disposed around touch screen 120, rather than being displayed on touch screen 120. For example, the time scale marks 1 to 12 may be disposed on the mechanical housing or body of wearable device 10. As shown in FIG. 3, in the third embodiment of the present invention, the first touch event corresponds to a user sequentially touching or sliding among touch-sensitive areas 131, 129, 125, 123 and 127. Assuming the first action event has occurred (the user moves his hand to look at wearable device 10), processor 13 then determines whether the first touch event has occurred and, if so, releases wearable devise from a locked state.

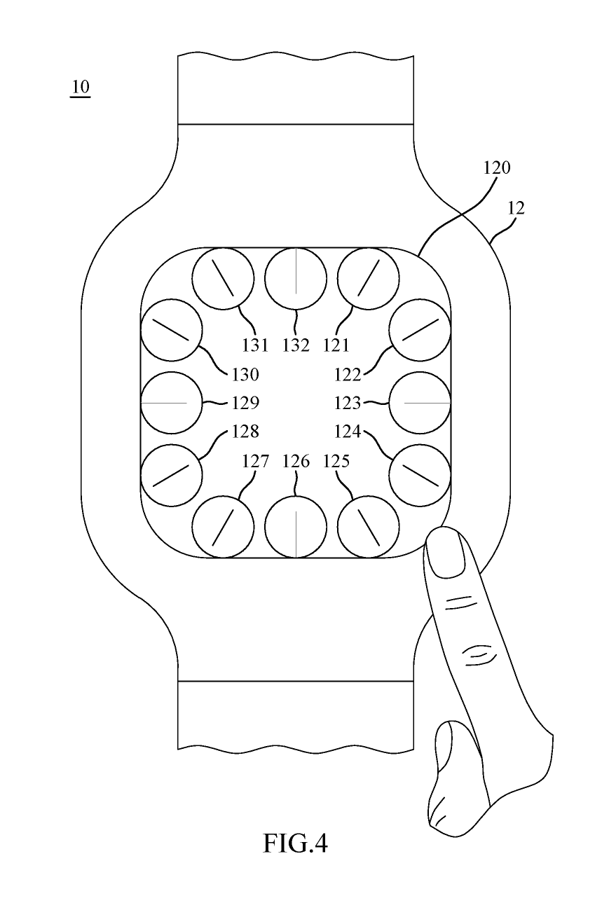

FIG. 4 depicts a face 12 of wearable device 10 according to a fourth embodiment of the present invention. Since most users are able to discern the displayed time on a watch by checking the hour hand and minute hand orientations, many wearable devices on the market have display patterns similar to wearable device 10 shown in FIG. 4. Thus, the instant embodiment is different from the second and third embodiments in that the tick marks are all the same “|” symbol, but in different orientations depending on the placement around the face 12. In this case, touch-sensitive areas 121-132 are co-located with the tick marks on touch screen 120. However, those skilled in the art will appreciate that the tick marks can also be arranged on the mechanical housing of wearable device 10, as in FIG. 3.

In sum, in the first through the fourth illustrated embodiments of the present invention, a user need not follow the traditional smart phone unlock methods or unlock patterns, including first pressing a power button, and then clicking on the touch screen numeric keypad or rolling over a preset unlock password. Instead, a predetermined first action event (i.e., a particular movement) can cause wearable device 10 to be ready to receive a touch input.

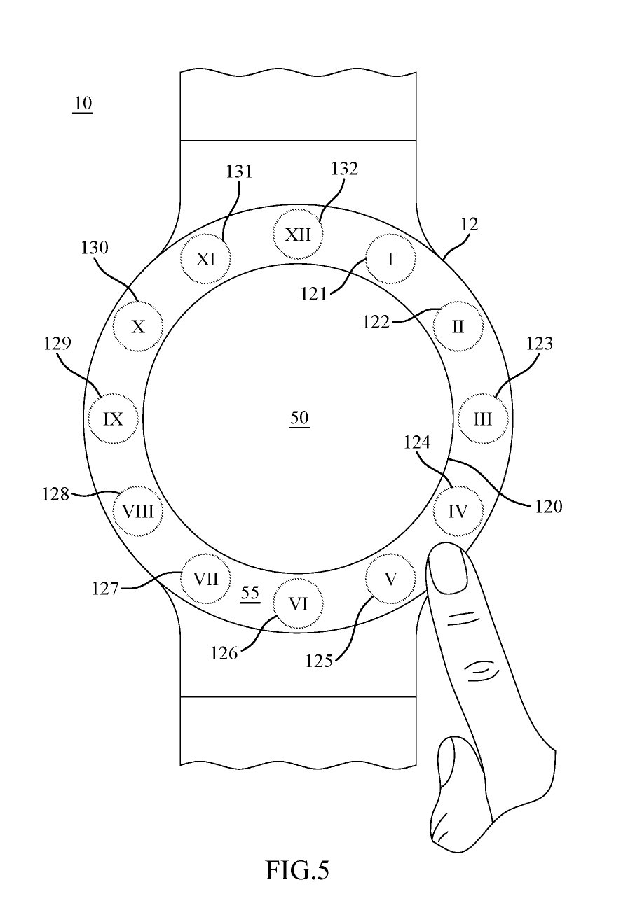

FIG. 5 depicts a face 12 of wearable device 10 according to a fifth embodiment of the present invention. In the fifth embodiment of the present invention, the touch-sensitive areas 121 to 132 are disposed on a periphery of the touch screen 120, and tick marks M1-M12 (timescale marks I-XII) are co-located therewith. Thus, touch screen 120 can be considered to have two areas: a first area 50 and a second, (in this case) annular area 55 surrounding first area 50. In an embodiment, first area 50 is not an active touch area. In this fifth embodiment, when a user touches at least two of the timescale marks I-XII in a particular order in second area 55, the first touch event can be triggered or determined. As such, processor 13 can release the lock state of wearable device 10.

It is noted that, for the several embodiments described above, processor 13 can be configured to not only determine whether a given sequence/slide has occurred, but also to determine whether a given sequence/slide has occurred within a predetermined amount of time. For example, and in connection with the instant fifth embodiment, processor 13 may be configured to determine “within a predetermined time (e.g., one second), whether touch-sensitive area 123 has been touched twice, touch-sensitive area 128 has been touched once, and finally touch-sensitive area 132 has been touched three times.” Such a touch event, if completed in, e.g., one second, would unlock wearable device 10.

In addition, it is worth noting that the first to the fifth embodiments of the present invention were explained in connection with movements for checking the time on the wearable device as the first action event to initiate an unlocking function. In another implementation, processor 13 can be configured to determine whether a second action event has occurred, and then to determine whether a related second touch event has occurred. The second action event might be, for example, a user twisting his wrist two or three times. Such an action, could be used, for example, to set the password that will then be used to unlock the wearable device, or to cause the wearable device to initiate execution of a particular application on the wearable device.

Further, it is worth noting that according to the first through the fifth embodiments of the present invention, the movements related to checking time on the wearable device can also be used to perform a locking function. For example, processor 13 can be configured to monitor output values of acceleration sensor 11 when in an un-locked state to determine whether a third action event (perhaps the same as the first action event) has occurred. Processor 13 is further configured to determine whether a particular sequence of touches (perhaps the same used for un-locking) has been made to touch-sensitive areas 121 to 132.

Further still, it is worth noting that the first to the fifth embodiments of the present invention may further take into account a predetermined time between which the first, second or third action event occurs and the time a corresponding touch event has occurred. If a corresponding touch event has not occurred within the predetermined time period (e.g., 3 seconds), then processor 13 may be configured to disregard any subsequent touch input that could be related to the first, second or third action event. That is, the first, second or third action event can be considered to be unintentional, and processor 13 may be configured to thus ignore such events.

Further still, it is worth noting that according to the first through the fifth embodiments disclosed herein tick marks M1-M12 may take on any form of mark, symbol or pattern, and the number of tick marks is not limited to 12, but can be any number greater than one. Tick marks M1-M12 may also have the same mark, symbol or pattern, and be arranged with different orientations on face 12 of wearable device 10.

Likewise, the number of touch-sensitive areas on touch screen 120 is not limited to 12. The number is preferably greater than 1, and the number of tick marks can be equivalent to the number of touch-sensitive areas, or to any number of touch sensitive areas. That is, each tick mark may correspond to a single touch-sensitive area, or to multiple (e.g., three) touch-sensitive areas. When more touch-sensitive areas are used, it may be possible to more accurately identify an intended selection of a tick mark.

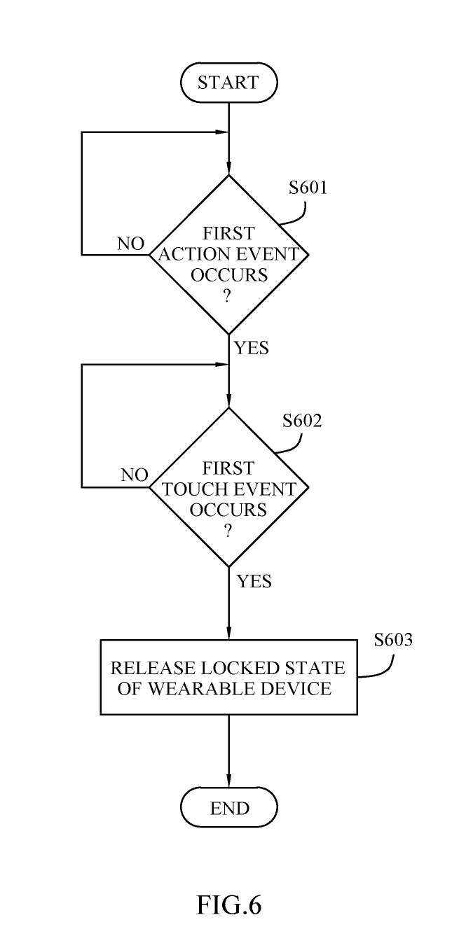

FIG. 6 depicts a flowchart of a method for unlocking a wearable device in accordance with an embodiment of the present invention. At step S601, processor 13 determines whether wearable device 10 has been moved in accordance with a first action event. If no, the process repeats step 601. If yes, the process continues with step S602. At step S602, processor 13 determines whether a first touch event has occurred. The touch event is a predetermined sequence of touched touch-sensitive areas, e.g., areas 121 to 132 of wearable device 10. If no touch event is detected, step S602 is repeated. However, as explained above, whether step S602 is repeated may be governed or controlled by a predetermined period from the time that the first action event occurred. If the first touch event has occurred (within the predetermined time period, as configured), the process proceeds to step S603 at which processor 13 releases the locked state or sleep state of the wearable device 10, enabling access to data and applications on wearable device 10.

It is noted, finally, that processor 13 may be, for example, a central processing unit (CPU), or other general purpose programmable microprocessor or special purpose microprocessor, digital signal processor (DSP), programmable controller, application-specific integrated circuit (ASIC), programmable logic device (PLD), or other similar device, or a combination of such devices. In the present embodiment, processor 13 may control the overall operation of wearable device 10.

The above description is intended by way of example only.

What is claimed is:

1. A method of operating a wearable device having a touch screen, the method comprising:
determining whether a first action event has occurred with the wearable device by monitoring an output of an acceleration sensor of the wearable device;
after determining that the first action event has occurred, determining whether a first touch event has occurred by monitoring whether touch-sensitive areas on a touch screen of the wearable device have been touched in a predetermined sequence; and
releasing a lock state of the wearable device when the first touch event has occurred.

2. The method of claim 1, wherein the first action event comprises a movement consistent with a user's arm moving to look at the wearable device.

3. The method of claim 1, wherein the touch sensitive areas correspond to tick marks on the wearable device.

4. The method of claim 3, wherein the tick marks correspond to markings of a timescale of a watch.

5. The method of claim 1, further comprising determining that the first touch event has occurred when the touch-sensitive areas on the touch screen of the wearable device have been touched in a predetermined sequence within a predetermined period of time.

6. The method of claim 1, further comprising releasing a lock state of the wearable device when the first touch event has occurred only when the first touch event occurs within a predetermined amount of time from a time the first action event has occurred.

7. The method of claim 1, further comprising determining whether a second action event has occurred with the wearable device by monitoring an output of an acceleration sensor of the wearable device;
after determining that the second action event has occurred, determining whether a second touch event has occurred by monitoring whether touch-sensitive areas on the touch screen of the wearable device have been touched in a predetermined sequence; and
performing an operation on the wearable device when the second touch event has occurred.

8. The method of claim 7, wherein the operation comprises setting a password for the wearable device.

9. The method of claim 1, further comprising placing the wearable device in a locked state from an un-locked state by determining whether the first action event has again occurred with the wearable device by monitoring an output of an acceleration sensor of the wearable device;
after determining that the first action event has again occurred, determining whether the first touch event has again occurred by monitoring whether touch-sensitive areas on the touch screen of the wearable device have been touched in a predetermined sequence; and
placing the wearable device in a locked state when the first touch event has again occurred.

10. A wearable device, comprising:
a touch screen;
an acceleration sensor; and
a processor in communication with both the touch screen and the acceleration sensor, the processor configured to:
determine whether a first action event has occurred with the wearable device by monitoring an output of the acceleration sensor;
after determining that the first action event has occurred, determine whether a first touch event has occurred by monitoring whether touch-sensitive areas on the touch screen have been touched in a predetermined sequence; and
release a lock state of the wearable device when the first touch event has occurred.

11. The wearable device of claim 10, wherein the first action event comprises a movement consistent with a user's arm moving to look at the wearable device.

12. The wearable device of claim 10, further comprising tick marks and the touch sensitive areas correspond to the tick marks.

13. The wearable device of claim 12, wherein the tick marks correspond to markings of a timescale of a watch.

14. The wearable device of claim 10, wherein the processor is further configured to determine that the first touch event has occurred when the touch-sensitive areas on the touch screen of the wearable device have been touched in a predetermined sequence within a predetermined period of time.

15. The wearable device of claim 10, wherein the processor is further configured to release a lock state of the wearable device when the first touch event has occurred only when the first touch event occurs within a predetermined amount of time from a time the first action event has occurred.

16. The wearable device of claim 10, wherein the processor is further configured to determine whether a second action event has occurred by monitoring an output of the acceleration sensor;
after determining that the second action event has occurred, determine whether a second touch event has occurred by monitoring whether touch-sensitive areas on the touch screen have been touched in a predetermined sequence; and
perform an operation on the wearable device when the second touch event has occurred.

17. The wearable device of claim 16, wherein the operation comprises setting a password for the wearable device.

18. The wearable device of claim 10, wherein the processor is further configured to place the wearable device in a lock state from an un-locked state by determining whether the first action event has again occurred by monitoring an output of an acceleration sensor of the wearable device;
after determining that the first action event has again occurred, determine whether the first touch event has again occurred by monitoring whether touch-sensitive areas on the touch screen of the wearable device have been touched in a predetermined sequence; and
place the wearable device in a locked state when the first touch event has again occurred.
